(19) United States
(12) Patent Application Publication
(10) Pub. No.: US 2025/0239085 A1
(43) Pub. Date: Jul. 24, 2025

(54) VELOCITY CORRECTION IN OBJECT POSE DETERMINATION

(71) Applicant: Ford Global Technologies, LLC, Dearborn, MI (US)

(72) Inventor: Xiufeng Song, San Jose, CA (US)

(73) Assignee: Ford Global Technologies, LLC, Dearborn, MI (US)

(21) Appl. No.: 18/416,956

(22) Filed: Jan. 19, 2024

(51) Int. Cl. G06V 20/56; G01S 7/48; G06V 10/70

(52) U.S. Cl. CPC G06V 20/56; G01S 7/4808; G06V 10/70

(57) ABSTRACT

A computer includes a processor and a memory, the memory stores instructions executable by the processor to generate first and second sets of points from first and second scans obtained from a lidar sensor, to determine a first velocity-compensated position of an object represented by a third set of points at a first validity time that is between respective times of the first and second scans. The instructions can additionally be to receive a parameter from the memory of the computer, in which the parameters are determined from a training process to modify an amodal representation of the object, the modified amodal representation being determined from a difference between a second velocity-compensated position of the object and an unmodified amodal representation of the object. The instructions can additionally be to determine a pose of the object represented by the third set of points based on the parameter.

### BACKGROUND

Modern vehicles can include a variety of sensors. Some sensors can detect static or moving objects external to the vehicle, such as other vehicles, lane markings of a roadway, traffic lights and/or signs, animals, natural objects, etc. Types of vehicle sensors can include radar sensors (e.g., wide beam or narrow beam radar sensors), ultrasonic sensors, sensors of a satellite positioning system (e.g., GPS), and light detection and ranging (lidar) devices. Output signals from sensors can be utilized by control units or the like that provide output related to vehicle operation, including to control one or more vehicle components.

### BRIEF DESCRIPTION OF THE DRAWINGS

FIG. 1 is a block diagram of an example vehicle.

FIG. 2A shows a system for processing an example scene, which includes a static vehicle viewable by a lidar or a radar sensor.

FIG. 2B shows a system for processing an example scene, which includes a moving vehicle viewable by a lidar or a radar sensor.

FIG. 3A is an example graph showing locations of sets of points determined via scans of a lidar or a radar sensor.

FIG. 3B is an example graph showing locations of velocity-corrected sets of points determined via scans of a lidar or a radar sensor.

FIG. 4 is a schematic diagram of an example training environment that generates a parameter for use in a vehicle computer.

FIG. 5 is an example timeline showing interpolation between first and second sets of points determined via scans of a vehicle lidar or radar sensor.

FIG. 6 is a flowchart of a process for velocity correction in object pose determination.

FIG. 7 is a flowchart for a process of utilizing a velocity correction parameter in a vehicle to determine the pose of an object.

### DETAILED DESCRIPTION

This disclosure describes techniques that can be provided for control or operation of a machine, such as a vehicle operated in a traffic environment. Such techniques can include those utilized to determine the pose (i.e., position and orientation) of a static or moving object that is viewable by a lidar or other type of sensor that generates a set of points utilizing energy reflected from a surface of the static or moving object. In an example, a lidar sensor can generate pulses of a coherent collimated light beam that are reflected from a surface of a static or moving vehicle during a lidar scan. The lidar sensor can output data that includes a measurement of a distance from the lidar sensor to a point on the surface of the object, which may include a static or moving vehicle. Via collection of, for example, a plurality of points reflected from the static or moving object, the lidar sensor can output data that represents a set of points, e.g., a point cloud, in which each point represents a particular location on the surface of the static or moving object.

In another example, a narrow beam radar sensor, such as a radar sensor utilizing a phased array antenna to direct pulses of an RF, microwave, or millimeter wave signal toward a static or moving object, can be utilized in place of, or in addition to, a lidar sensor. In such an example, the narrow beam radar sensor can operate to output data that includes a measurement of the distance from the narrow beam radar sensor to a point on the surface of the static or moving object. Via collection of a plurality of points reflected from the static or moving object, the narrow beam radar sensor can output data that represents a set of points, in which each point represents a particular location on the surface of the static or moving object.

In an example, a lidar sensor, such as a vehicle-mounted lidar sensor, can operate by scanning, e.g., in elevation and azimuth, with respect to a lens or other type of sensing surface of the lidar sensor. In an example, a vehicle-mounted lidar sensor can perform a measurement scan of a 360° field-of-view, e.g., in azimuth, with respect to the lidar sensor over a duration of 100 milliseconds, 500 milliseconds, one second, etc. Accordingly, as a lidar-equipped vehicle, for example, moves along path of travel 50 in a traffic environment, the lidar sensor can generate dozens or perhaps hundreds of sets of points, in which each set of points represents the pose of individual objects in a traffic environment. Responsive to obtaining output data representing the various sets of points from the lidar sensor, a vehicle computer, for example, can classify the sets of points according to a plurality of classifications. In an example, output signals representing a set of measurement points on an object detected by a lidar sensor can be transmitted to a vehicle computer that executes instructions to classify and/or label the static or moving object based on the geometric characteristics and/or the pose of the object represented by the set of measurement points. Such classifications or labels can denote a stationary vehicle, a moving vehicle, a lamp post, a traffic sign, an abutment, a natural object (e.g., a tree, a shrubbery, a rock, etc.), a bicycle, and so forth. In an example, a set of points can be classified as a rear surface of a vehicle based on points of the set of points conforming to a predetermined shape and/or being within a relatively small distance of other points of the set of points, e.g., within 0.25 meter, 0.5 meter, etc., with respect to the receiving surface of a vehicle-mounted lidar sensor.

In another example, a narrow beam radar sensor, such as a vehicle-mounted radar sensor can operate similar to a vehicle-mounted lidar sensor. In such an example, as a radar-equipped vehicle moves along path of travel 50 in a traffic environment, the radar sensor can generate dozens or perhaps hundreds of sets of points, in which each set of points represents the pose of individual objects in a traffic environment. Responsive to obtaining output data representing the various sets of points from the radar sensor, a vehicle computer can classify the sets of points according to a plurality of classifications. In an example, output signals representing a set of measurement points of an object detected by a radar sensor can be transmitted to a vehicle computer that executes instructions to classify and/or label the static or moving object based on the geometric characteristics and/or the pose of the object represented by the set of radar-measured points. Classifications or labels can denote a stationary vehicle, a moving vehicle, a lamp post, a traffic sign, an abutment, a natural object (e.g., a tree, shrubbery, rock, etc.), a bicycle, and so forth.

In an example, instructions executed by a vehicle computer, for example, can assign a three-dimensional geometric container to a set of measurement points obtained during a scan of a lidar sensor and/or during a scan of a narrow beam radar sensor. In this context, a “geometric container” means a system or set of bent or unbent lines that encompasses the volume of a set of points detected by a sensor and assembled via programming of a vehicle computer. For example, based on successive lidar or radar sensor scans of an object, such as lidar or radar sensor scans of rear and side portions of a moving object, instructions executed by a vehicle computer can assign a geometric container such as a hexahedron (i.e., a geometric container having rectangular left, right, top, and bottom sides, and square front and back sides), a cuboid (i.e., a geometric container having square left, right, top, bottom, front, and back sides, or a cuboid having a fattened appearance (i.e., a geometric container having one or more square sides and one or more boundaries having bent or bowed edges). In this context, a “cuboid” means a three-dimensional geometric container having a top side, a bottom horizontally-oriented side, two opposing laterally-oriented (i.e., left hand and right hand) sides, and two additional laterally-oriented (i.e., rear and front) sides that encompass a stationary or moving object derived or ascertained from a set of measurement points resulting from a lidar or radar sensor scan. In an example, a cuboid can encompass the volume of an object such as a car, a bus, a bicycle, a truck, a camper trailer, or any other static or moving object that may be present in a traffic environment. In an example, instructions executed by a vehicle computer can track or monitor the motion of the cuboid as the object represented by the cuboid moves with respect to the vehicle-mounted lidar or radar sensor.

In a traffic environment, responsive to an object being in motion with respect to a vehicle-mounted lidar or radar sensor, the object can undergo displacement during the sensor scan. In an example, one or more points of a set of points reflected from an object during a beginning portion of a sensor scan can appear to be displaced with respect to one or more points measured during an end portion of the sensor scan. For example, an object traveling at 10 meters per second (approximately 22.4 miles per hour) can undergo 1.0 meters of displacement during a lidar or radar scan occurring over a 100-millisecond duration. Accordingly, aggregating, e.g., via instructions executed by a vehicle computer, displacement of points of the set of points obtained during the 100-millisecond lidar or radar sensor scan can introduce discrepancies in determining the actual location of points of the set of points that represent the object with respect to the location of the lidar or radar sensor. Such displacement of points of the set of points can result in programming of a vehicle computer constructing a cuboid having fattened or curved lines, which can degrade the capability of the vehicle computer, for example, to assign a class label to a moving object.

In addition, a vehicle-mounted lidar or radar sensor can utilize two or more simultaneously scanning laser beams, such as a first scanning beam capable of detecting objects at relatively large distances from the vehicle, such as, for example, distances of greater than 50 meters, greater than 100 meters, greater than 150 meters, etc., and a second scanning beam capable of detecting objects at lesser distances from the vehicle, such as distances of less than 50 meters, less than 25 meters, etc. In an example, at a first instant in time (e.g., time T₀), the first scanning lidar or radar beam can be directed toward areas forward of the vehicle while a second scanning laser may be directed toward areas to the rear of the vehicle. At a second instant in time (e.g., time T₁), the first scanning laser may be directed toward areas to the rear of the vehicle while the second scanning laser is directed toward areas forward of the vehicle. Accordingly, instructions executed by the vehicle computer may attempt to assemble a geometric container (e.g., a cuboid) representing an object via integration of output signals based on, for example, first and second lidar or radar scans occurring over the first and second scanning intervals (e.g., T₀ and T₁). In response to the detected object being in motion, instructions executed by the vehicle computer may form a relatively large geometric container, having significantly bent, bowed, or fattened boundaries. Such large geometric containers may further degrade a capability of the vehicle computer to assign a class label to and/or to determine the pose of a moving object.

In accordance with examples described herein, a set of points obtained via a sensor scan that represents a moving object can be velocity corrected, so as to form a geometric container having a shape that more closely conforms to a cuboid shape, having substantially unbent, e.g., horizontal and vertical lines defining boundaries of the cuboid, rather than another type of geometric container having bowed, fattened, bent, or lines of another shape to define the boundary of the geometric container. A capability to generate a cuboid having horizontal and vertical lines (or at least lines that are at least predominantly horizontal and vertical) can enhance an ability for instructions executed by a vehicle computer to label and/or classify a set of points representing a moving object. Such a capability can additionally increase an ability for a vehicle computer to separate sets of points representing a moving object from other sets of points representing other objects in the field-of-view, thereby enhancing a capability of a lidar or radar sensor, interacting with a vehicle computer, to label and/or classify other sets of points representing additional static or moving objects detected in a traffic environment.

In an example, a vehicle computer can utilize an amodal representation of a set of points, such as points representing the pose of a moving object detected in a traffic environment. In this context, an “amodal” or an “amodalized” representation of an object means a representation of the pose of an object obtained utilizing an aggregation of one or more historical sets of points that describe the distance to at least a portion of the object obtained during a previous sensor scan. Thus, in an example, an amodal or amodalized representation of a moving vehicle detected in a traffic environment may be obtained by aggregating historical sets of points obtained via previous lidar or radar sensor scans. Such lidar or radar sensor scans can include scans of a rear portion of the moving vehicle and/or a side portion of the moving vehicle, which may be aggregated via instructions executed by the vehicle computer. Via aggregation of past sensor scans, each of which may provide a set of points representing a vehicle detected from differing aspects, e.g., a left side portion of the vehicle, a right side portion of the vehicle, a rear portion of the vehicle, program instructions executed by the vehicle computer can form a cuboid of the vehicle, thus allowing the vehicle computer to track the pose of the three-dimensional volume of the vehicle as the vehicle moves within the traffic environment.

During an amodalization process, a vehicle computer can utilize a computed velocity of a moving object, obtained via successive, e.g., first and second, scans of the moving object, as an input to the amodalization process. The velocity of the moving object can be computed or inferred utilizing the first and second sets of points representing the moving object obtained during the sequential lidar or radar sensor scans. In an example, instructions executed by a vehicle computer can compute a first amodalized pose of a moving object to form a geometric container, such as a cuboid, which may include bent, bowed, or fattened lines defining the boundaries of the geometric container. The first amodalized representation of the moving object can represent the pose of the moving object at a first interpolated, e.g., a third, time between successive, e.g., first and second, lidar or radar sensor scans. After forming the first geometric container, the amodalization process can be executed again utilizing the computed or inferred velocity of the moving object as input signals that operate to modify the amodalized representation. A geometric container formed responsive to the second execution of the amodalization process may include a geometric container (e.g., a cuboid) having straightened or less bent, less bowed, or less fattened lines defining the boundaries of the geometric container. Based on the cuboid being less bent, less bowed, or less fattened, instructions executed by the vehicle computer can compute a second velocity of the moving object at a second selectable interpolation time, so as to align the modified amodalized pose of the object with an interpolated or third set of points derived from the successive, e.g., first and second, lidar or radar sensor scans. Thus, in an example, a process of iterating to determine a time at which amodalization, utilizing a computed or inferred velocity of a moving object, results in a geometric container (e.g., a cuboid) having substantially unbent, unbowed, lines defining the geometric container.

In an example, a vehicle computer can obtain a parameter, or a set of parameters, in response to training of an off-line computer, which may include an off-line computer implementing a machine learning application in a supervised, unsupervised, or reinforcement learning environment. Based on training of a machine learning application, a parameter, or set of parameters, can be transmitted to an onboard vehicle computer, which can permit the vehicle computer to execute instructions to align an amodalized pose of a moving object encountered in a traffic environment with a set of points determined or derived from successive lidar or radar sensor scans. Accordingly, an onboard vehicle computer can consume reduced processing resources in forming an amodalized pose that represents a moving object, such as a geometric container (e.g., a cuboid) of the moving object, having straightened, less bent, less bowed, or less fattened lines defining the boundaries of the container. In an example, a geometric container (e.g., a cuboid) having straightened, i.e., less bent, less bowed, or less fattened lines, can enhance the capability for the vehicle computer to assign a class label to the moving object and to determine the actual pose of the moving object in a traffic environment. Via determining the pose of the moving object, the vehicle computer can provide output to control or govern one or more vehicle operations or components, thus, for example, providing assistance to a vehicle operator in a traffic environment.

In an example, a system can include a computer having a processor and a memory, in which the memory can include instructions executable by the processor to generate first and second sets of points from first and second scans obtained from a lidar sensor or from a radar sensor. The instructions can additionally include instructions to determine a first velocity-compensated position of an object represented by a third set of points at a first validity time that is between respective times of the first and second scans and to receive a parameter from the memory of the computer, the parameter being determined from a training process to modify an amodal representation of the object, the modified amodal representation being determined from a difference between a second velocity-compensated position of the object and an unmodified amodal representation of the object. The instructions can additionally include instructions to determine the pose of the object represented by the third set of points based on the parameter.

In an example, the parameter can be generated from an iterative adjustment of the amodal representation of the object, the iterative adjustment of the amodal representation being based on a difference between the second velocity-compensated position of the object and the modified amodal representation of the object being greater than a threshold value.

In an example, the parameter can be determined from the iterative adjustment of the amodal representation of the object terminating in response to the second velocity-compensated position of the object and the modified amodal representation of the object being less than the threshold value.

In an example, the iterative adjustment of the amodal representation of the object can occur via supervised machine learning.

In an example, the amodal representation of the object can be determined from an aggregated history of scans of the object.

In an example, the instructions can further include instructions to generate a geometric container that includes the third set of points and to assign a class label to the geometric container.

In an example, the class label assigned to the geometric container can be a cuboid encompassing a vehicle.

In an example, the instructions can further include instructions to actuate a vehicle component based on the determined pose of the object.

In an example, the vehicle component can be a steering component or a propulsion component of the vehicle.

In an example, the parameter can represent the first validity time at which the modified amodal representation of the object is computed.

In an example, the first validity time can be determined from an interpolation between the unmodified amodal representation of the object and the modified amodal representation of the object.

In an example, a method can include generating first and second sets of points from first and second scans obtained from a lidar sensor or from a radar sensor. The method can additionally include determining a first velocity-compensated position of an object represented by a third set of points at a first validity time that is between respective times of the first and second scans. The method can additionally include receiving a parameter from a computer memory, the parameter being determined from a training process to modify an amodal representation of the object, the modified amodal representation being determined from a difference between a second velocity-compensated position of the object and an unmodified amodal representation of the object. The method can further include determining a pose of the object represented by the third set of points based on the parameter.

In an example, the parameter can be determined from an iterative adjustment of the amodal representation of the object, the iterative adjustment of the amodal representation being based on a difference between the second velocity-compensated position of the object and the modified amodal representation of the object being greater than a threshold value.

In an example, the parameter can be determined from the iterative adjustment of the amodal representation of the object terminating in response to the second velocity-compensated position of the object and the modified amodal representation of the object being less than the threshold value.

In an example, iterative adjustment of the amodal representation of the object can occur via a supervised machine learning environment.

In an example, the amodal representation of the object can be determined from an aggregated history of scans of the object.

In an example, the method can further include generating a geometric container that includes the third set of points and assigning a class label to the geometric container.

In an example, the method can further include actuating a vehicle component based on the determined pose of the object.

In an example, the vehicle component can be a steering component or a propulsion component.

In an example, the parameter can represent the first validity time at which the modified amodal representation of the object is computed.

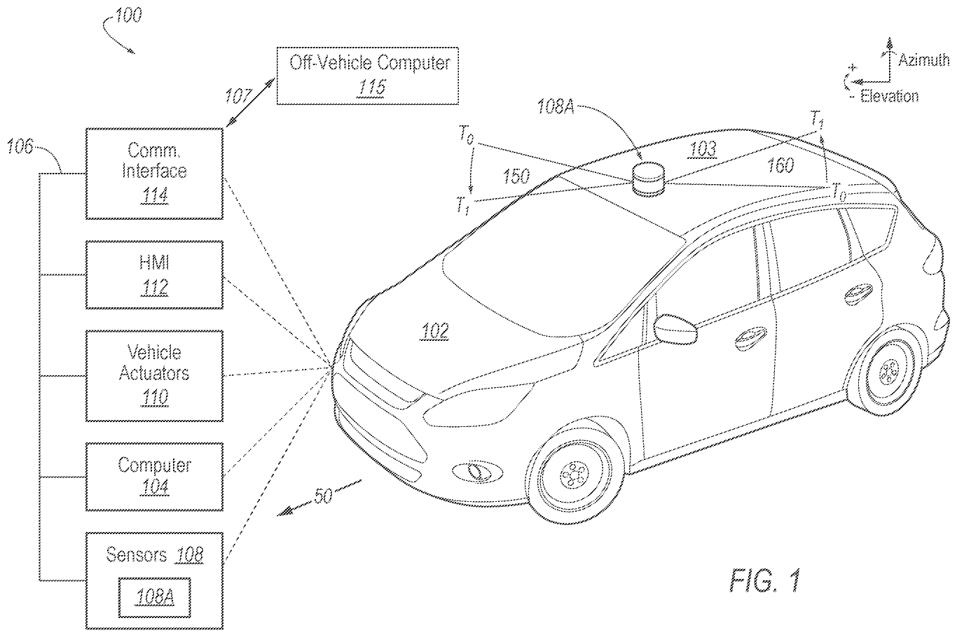

FIG. 1 is a block diagram of an example vehicle 100. Vehicle 100 can be any passenger or commercial automobile such as a car, a truck, a recreational vehicle, a sport utility vehicle, a crossover, a van, a minivan, a taxi, a bus, etc. Vehicle 100 can include computer 104, communications network 106, sensor set 108, vehicle actuators 110, human-machine interface (HMI) 112, communications interface 114 (e.g., to provide Wi-Fi communications, communications with a satellite or terrestrial network, communications with other vehicles, etc.). In an example, communications interface 114 can communicate with off-vehicle computer 115 via wide area network 107. In an example, off-vehicle computer 115 may perform velocity correction of amodalized sets of points, which may assist (or replace) amodalization functions performed by vehicle computer 104. In an example, off-vehicle computer 115 can represent a cloud computing service provider, such as Amazon.com, Inc. located at 410 Terry Ave. N Seattle, WA 98109.

Sensor set 108 may include a camera sensor, a long-range radar sensor, an ultrasonic sensor, and lidar/radar sensor 108A. Sensor set 108 can additionally include navigation sensors, such as sensors of a satellite positioning system (e.g., GPS), sensors of an inertial measurement unit, etc. In an example, lidar/radar sensor 108A can be mounted on upward and/or external-facing structure 103 of vehicle body 102. In an example, sensor 108A can include a lidar sensor having a laser emitter for emitting a coherent collimated beam of energy that can be directed at any azimuth angle with respect to the longitudinal axis of vehicle body 102. In another example, sensor 108A can include a radar sensor having an RF, microwave, or millimeter wave antenna for emitting a signal that can be directed at any azimuth angle with respect to the longitudinal axis of vehicle body 102. Lidar/radar sensor 108A can operate by emitting the beam of energy over a brief period, e.g., a pulse width of 0.1 microsecond, one microsecond, two microseconds, etc., and measuring the time for a reflected pulse to return to a detector of lidar/radar sensor 108A. Lidar/radar sensor 108A can transmit and receive thousands, hundreds of thousands, or another number of pulses in a single second, so as to output a set of reflected measurement points that can be utilized by the lidar lidar/radar sensor to compute distances to static or moving objects in the traffic environment of vehicle 100. In the example of FIG. 1, lidar/radar sensor 108A operates by scanning in azimuth (e.g., 360°) and in elevational angles of ±−10°, ±15°, ±−20°, or another range of elevational angles with respect to vehicle body 102.

In the example of FIG. 1, lidar/radar sensor 108A provides a capability for simultaneous sensor scanning in opposing directions. As shown in FIG. 1, at a first time, lidar/radar sensor 108A can scan in a direction forward of vehicle body 102 while scanning in a direction to the rear of the vehicle body. In an example, at a first instant, lidar/radar sensor 108A can generate a beam in a direction forward of vehicle body 102 that is oriented in a first direction (e.g., in azimuth and elevation) at a time T₀ and oriented in a second direction at a time T₁. Accordingly, during a first scan duration (e.g., T₀ to T₁) lidar/radar sensor 108A can simultaneously transmit laser signals and receive reflected returns from objects located in a forward direction and from objects located to the rear of vehicle body 102. Lidar/radar sensor 108A may subdivide scanning, e.g., in azimuth, into sectors during which a set of laser pulses are emitted and subsequently received. In an example, lidar/radar sensor 108A may subdivide scanning in 360° of azimuth into 18 sectors, in which each sector includes a field-of-view, such as fields-of-view 150, that subtends 20° of arc in the azimuthal plane.

In an example, lidar/radar sensor 108A can continuously or intermittently scan regions around vehicle body 102. Thus, in an example, at a first instant, scanning of field-of-view 150 can output a set of measurement points located in a forward direction with respect to vehicle body 102. At a second instant, field-of-view 150 can output a set of measurement points located to the rear of vehicle body 102. Accordingly, fields-of-view 150 and 160 can alternate between being oriented in forward directions with respect to vehicle body 102 and in directions rearward of vehicle body 102, thus providing continuous scanning of all, or substantially all, areas external to vehicle body 102. In an example, a first pulsed beam emitted from lidar/radar sensor 108A can include signals having greater output power than a second pulsed beam emitted from the lidar/radar sensor. Thus, as lidar/radar sensor 108A rotates or sweeps, fields-of-view 150 and 160 rotate in azimuth with respect to vehicle body 102. Thus, objects detected within field-of-view 150 may include objects located at a greater distance from vehicle body 102 than objects detected within field-of-view 160. By utilizing differing beam output power levels, lidar/radar sensor 108A can include a capability for detecting static or moving objects that may be proximate (e.g., up to 50 meters, up to 25 meters, up to 10 meters, etc.) to vehicle body 102 as well as static or moving objects that may be located further (e.g., up to 75 meters, up to 100 meters, up to 200 meters, etc.) from vehicle body 102.

Vehicle actuators 110 can include actuators to control a propulsion system to translate stored energy (e.g., gasoline, diesel fuel, electric charge, etc.) into motion to propel vehicle 100. Vehicle actuators 110 may include actuators to control a conventional vehicle propulsion subsystem, for example, a conventional powertrain including an internal-combustion engine coupled to a transmission that transfers torque generated by the engine to the wheels of vehicle 100. Vehicle actuators 110 can also include actuators to control a hybrid powertrain that utilizes elements of a conventional powertrain and an electric powertrain; or may include another type of powertrain. Vehicle actuators 110 can include an electronic control unit (ECU) or the like that is in communication with, and/or receives input from, vehicle computer 104 and/or a human operator. The human operator may control the propulsion system and/or a gear-shift lever.

Vehicle actuators 110 can include actuators to control a conventional vehicle steering subsystem to turn the wheels of vehicle 100. The steering subsystem may include rack-and-pinion steering members with electric power-assisted steering, a steer-by-wire system, or another suitable system. The steering subsystem can include an electronic control unit (ECU) or the like that is in communication with and receives input from vehicle computer 104 and/or a human operator. The human operator may control the steering subsystem via, e.g., a steering wheel.

HMI 112 presents information to and receives information from an operator of vehicle 100. HMI 112 may include controls and displays positioned, for example, on an instrument panel in a passenger compartment of vehicle 100 or may be positioned at another location that is accessible to the operator of vehicle 100. HMI 112 can include dials, digital displays, screens, speakers, etc., for providing information to the operator of vehicle 100. HMI 112 can include buttons, knobs, keypads, microphones, and so on for receiving information from an operator of vehicle 100.

Vehicle 100 can additionally include vehicle actuators 110, which operate to apply a mechanical or electromotive force to control an aspect of vehicle 100. For example, vehicle actuators 110 can include a steering actuator, which operates to modify the orientation of the front wheels of vehicle 100, responsive to input from a human operator and/or a vehicle computer. In another example, actuators 110 can include a vehicle propulsion component, which operates to reposition a throttle control of vehicle 100, so as to increase or decrease the speed of vehicle 100.

Computer 104 of vehicle 100 and/or off-vehicle computer 115 can include a microprocessor-based computing device, e.g., a generic computing device, which includes a processor and a memory, an electronic controller or the like, a field-programmable gate array (FPGA), a system-on-a-chip, an application-specific integrated circuit (ASIC), a combination of the foregoing, etc. In an example, a hardware description language such as VHDL (VHSIC (Very High Speed Integrated Circuit) Hardware Description Language) can be utilized in electronic design automation to describe digital and mixed-signal systems, such as FPGA and ASIC. For example, an ASIC is manufactured based on VHDL programming provided pre-manufacturing, whereas logical components inside an FPGA may be configured based on VHDL programming, e.g., stored in a memory coupled to the FPGA circuit. Vehicle computer 104 and/or off-vehicle computer 115 can thus include a processor, a memory, etc. A memory of computer 104 and/or off-vehicle computer 115 can include a tangible media for storing instructions executable by the processor as well as for electronically storing data and/or databases. Alternatively or in addition, computer 104 and/or off-vehicle computer 115 can include structures, such as the foregoing, by which executable instructions are provided. In an example, computer 104 and/or off-vehicle computer 115 can be multiple computers coupled together to operate as a single computing resource.

Vehicle computer 104 may transmit and receive data through communications network 106. Communications network 106 can include, e.g., a controller area network (CAN) bus, Ethernet, WiFi, Local Interconnect Network (LIN), onboard diagnostics connector (OBD-II), and/or another wired or wireless communications network. Vehicle computer 104 may be communicatively coupled to lidar/radar sensor 108A, vehicle actuators 110, HMI 112, communications interface 114 and other vehicle systems and/or subsystems via communications network 106.

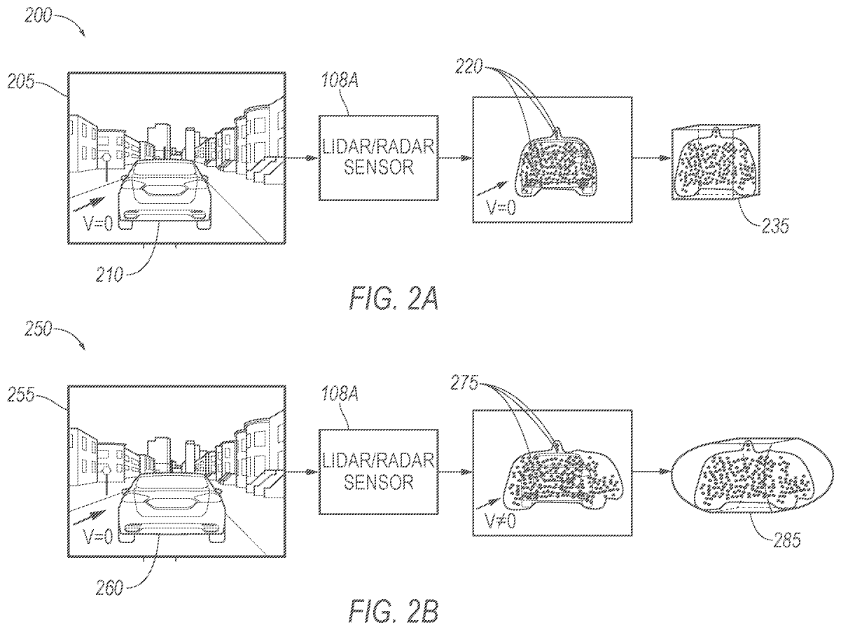

Vehicle computer 104 can execute instructions to perform signal processing of sets of points representing objects detected via lidar/radar sensor 108A. As described in greater detail in reference to FIGS. 2-5 herein, instructions executed by computer 104 can operate to assemble sets of points from outputs of lidar/radar sensor 108A to identify and/or classify such points as representing static or moving objects in the traffic environment of vehicle 100. Based on repeated detections of sets of points, computer 104 can execute instructions to amodalize sets of detected points representing an object utilizing past sets of points representing historical sets of points that represent the object. In addition, an object detected at a first and second scan times (e.g., T₀ and T₁). In addition, instructions executed by vehicle computer 104 can operate to compute a velocity of a moving object and interpolate, e.g., utilizing an optimization filter (i.e., a Kalman filter, an extended Kalman filter, a particle filter, etc.), to update and refine the velocity of the moving object at a third point in between the successive, e.g., first and second, sensor scans. A velocity of a moving object, such as at an interpolated point, can be utilized as an input to an amodalized model of the moving object, so as to velocity correct the amodalized model. Based on a modified and velocity corrected amodalization of the moving object, the computed pose of the object can be aligned with a velocity inferred or interpolated from, for example, two or more measurements of the position of the moving object with respect to vehicle body 102.

Alternatively or in addition, off-vehicle computer 115, communicating with communications interface 114 of vehicle 100, may execute instructions to perform signal processing of sets of points representing objects detected via lidar/radar sensor 108A. In an example, instructions executed by off-vehicle computer 115 can operate to assemble sets of points from signals communicated, e.g., via wide area network 107, to assemble sets of points from outputs of lidar/radar sensor 108A. Off-vehicle computer 115 can operate to assemble sets of points from outputs of lidar/radar sensor 108A to identify and/or classify such points as representing static or moving objects in the traffic environment of vehicle 100. Based on repeated detections of sets of points, computer 104 can execute instructions to amodalize sets of detected points representing an object utilizing past sets of points representing historical sets of points that represent the object. In addition, an object detected at a first and second scan times (e.g., T₀ and T₁). In addition, instructions executed by vehicle computer 104 can operate to compute a velocity of a moving object and interpolate, e.g., utilizing an optimization filter (i.e., a Kalman filter, an extended Kalman filter, a particle filter, etc.), to update and refine the velocity of the moving object at a third point in between the successive, e.g., first and second, sensor scans. A velocity of a moving object, such as at an interpolated point, can be utilized as an input to an amodalized model of the moving object, so as to velocity correct the amodalized model. Based on a modified and velocity corrected amodalization of the moving object, the computed pose of the object can be aligned with a velocity inferred or interpolated from, for example, two or more measurements of the position of the moving object with respect to vehicle body 102.

In an example, instructions executed by vehicle computer 104 and/or off-vehicle computer 115 can utilize a parameter uploaded from a machine learning application of a training network that can include a neural network, which operates to define settings or weights utilized by computer 104 and/or off-vehicle computer 115. Settings or weights utilized by vehicle computer 104 and/or off-vehicle computer 115 can operate to reduce processing resources consumed by computer 104 involved in aligning an amodalized representation of the pose of a moving object with respect to a set of points derived from measurements scans of lidar/radar sensor 108A.

### Exemplary System Operations

FIG. 2A shows a system 200 for processing of example scene 205, which includes a static vehicle viewable by a lidar or a radar sensor. In the example of FIG. 2A, vehicle 210 can represent a stationary vehicle (V=0) among other objects, such as buildings, signposts, etc., which may be detectable in scene 205 utilizing vehicle-mounted lidar/radar sensor 108A. In an example, vehicle 210 can represent a stationary vehicle observable within fields-of-view 150 and 160 of lidar/radar sensor 108A. Accordingly, successive scans of lidar/radar sensor 108A can detect a surface of vehicle 210, which may result in set of points 220 that represent vehicle 210. As shown in FIG. 2A, the detected surface of vehicle 210 results in set of points 220 being constrained within a two-dimensional or a three-dimensional array of points, in which each point within set of points 220 represents a point on the body of vehicle 210. In addition, subsequent scans of vehicle 210 can result in inputs to an amodalization process executed by vehicle computer 104 for forming a cuboid having unbent lines encompassing the volume of vehicle 210, as shown by cuboid 235. In an example, in response to lidar/radar sensor 108A being in motion with respect to vehicle 210, instructions executed by vehicle computer 104 and/or off-vehicle computer 115 can compensate for changes in pose of vehicle 210 resulting from such motion (e.g., motion of sensor 108A relative to vehicle 210, which may be referred to as ego-motion) by translating coordinates of set of points 220 to a frame that is referenced to vehicle 100.

FIG. 2B shows a system 250 for processing of an example scene 255, which includes a moving vehicle viewable by a lidar/radar sensor. In the example of FIG. 2B, vehicle 260 can represent a moving vehicle among stationary objects, such as buildings, signposts, etc., which may be detected utilizing vehicle-mounted lidar/radar sensor 108A. In an example, vehicle 260 can represent a moving vehicle observable within fields-of-view 150/160 of lidar/radar sensor 108A. Accordingly, successive scans of lidar/radar sensor 108A can detect a surface of vehicle 210, which may result in set of points 220 that represent vehicle 260 as the vehicle moves in relation to vehicle 100. Based on vehicle 260 being in motion with respect to vehicle 100, successive scans performed by lidar/radar sensor 108A can result in certain points of set of points 275 being located outside of the actual or ground truth position of a particular surface of vehicle 260. Accordingly, in an example, during an initial portion of a scan of lidar/radar sensor 108A, the sensor may detect certain points of set of points 275 that are displaced from other points of set of points 275. In an example, displacement of points of set of points 275 can be expressed in accordance with expression (1) below:

$$Displacement = {\int }_{{T}_{p}}^{{T}_{STOV}} {V}_{p} ( t ) dt \qquad ( 1 )$$

In expression (1), Tₚ represents the time at which a point of set of points 275 is detected, T_{STOV} represents a scan time of validity, which denotes the time at which set of points 275 are aggregated into a single validity time during an amodalization process executed via computer 104 and/or off-vehicle computer 115. Vₚ(t) of expression (1) represents the velocity of the moving object represented by set of points 275. In this context, a “scan time of validity” or a “validity time” means an instant in time at which a set of points (e.g., 275) detected during a lidar or radar sensor scan are aggregated to form the set of points. Thus, in an example, instructions executed by vehicle computer 104 and/or off-vehicle computer 115 may attempt to aggregate a detected set of points into a single validity time. Instructions executed by vehicle computer 104 and/or off-vehicle computer 115 may thus attempt to accommodate all detected points into geometric container 285, which may include a cuboid having fattened, bent, or bowed lines bounding the geometric container. In an example, in response to geometric container 285 being shaped as a cuboid having fattened, bent, or bowed lines, a capability for computer 104 and/or off-vehicle computer 115 to classify vehicle 260 as representing a vehicle in a traffic environment can be degraded. Additionally, based on geometric container 285 being relatively large in relation to cuboid 235 of FIG. 2A, an ability for instructions executed by computer 104 and/or off-vehicle computer 115 to compute the pose of vehicle 260, and/or to detect other objects present in scene 255, may be degraded.

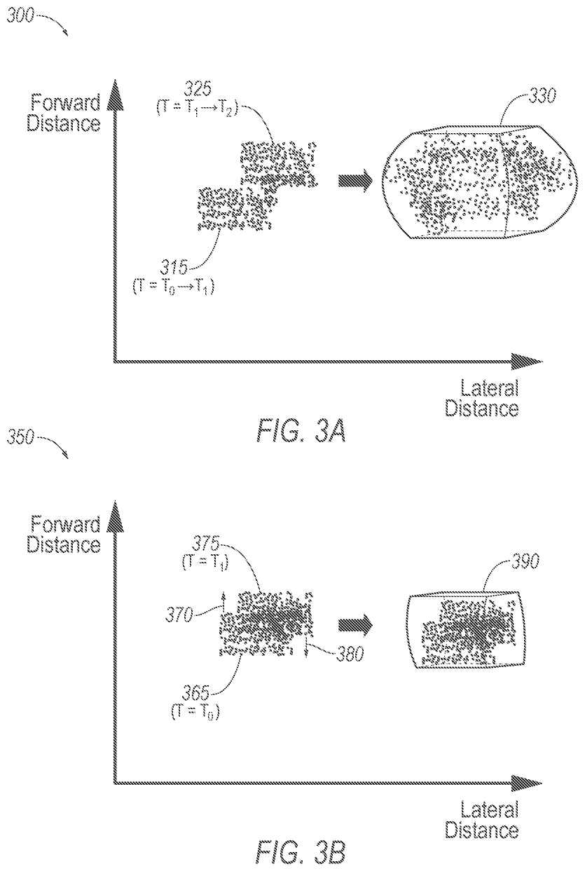

FIG. 3A is an example graph 300 showing locations of sets of points determined via scans of a lidar or radar sensor. In the example of FIG. 3A, set of points 315 can represent a set of points generated in response to a first scan by lidar/radar sensor 108A of an object in motion with respect to vehicle 100. Set of points 325 can represent a set of points generated in response to a second scan by lidar/radar sensor 108A of the object in motion. Accordingly, based on the relative motion of the object with respect to vehicle 100, programming of computer 104 can execute instructions to amodalize sets of points 315 and 325 to form a geometric container (e.g., cuboid 330) at a scan time of validity as described in relation to expression (1). In an example, an amodalization process results in vehicle computer 104 generating cuboid 330 at a scan time of validity, which includes bent, fattened, and/or bowed lines defining the boundaries of the cuboid. In an example, cuboid 330 may represent a relatively large geometric container with respect to a detected object in motion. In an example, for a moving object having a length, width, and height of one cubic meter, an amodalization process to generate cuboid 330 can result in a cuboid encompassing a volume of, for example, two cubic meters, three cubic meters, four cubic meters, etc. Accordingly, based on cuboid 330 encompassing a relatively large volume, other static or moving objects also viewable in scene 255, which may be located adjacent to the moving object, may remain undetected. Further, based on cuboid 330 encompassing a relatively large volume, vehicle computer 104 and/or off-vehicle computer 115 may consume increased processing resources in determining the pose and/or a class label of a vehicle represented by sets of points 315 and 325.

FIG. 3B is an example graph 350 showing locations of velocity-corrected sets of points determined via scans of a lidar or radar sensor. In the example of FIG. 3B, set of points 365 can represent a set of points generated in response to a first scan by lidar/radar sensor 108A of an object in motion with respect to vehicle 100. Set of points 375 can represent a set of points generated in response to a second scan by lidar/radar sensor 108A of the object in motion. Accordingly, based on the relative motion of the object with respect to vehicle 100, programming of computer 104 and/or off-vehicle computer 115 can be executed, including instructions to amodalize sets of points 365 and 375 to form a geometric container (e.g., cuboid 380) at a scan time of validity as described in relation to expression (1).

However, in the example of FIG. 3B, an amodalization process can be modified to include velocity correction inputs, which may be computed utilizing a velocity that is inferred or derived from two or more (e.g., subsequent) lidar or radar sensor scans. Accordingly, as shown in FIG. 3B, set of points 365 can be modified or adjusted to overlap with set of points 375. In an example, sets of points 365 and 375 can both undergo velocity correction, as indicated by arrows 370 and 380, so as to include a larger overlap with one another. Accordingly, in an example, an amodalization process executed by vehicle computer 104 and/or off-vehicle computer 115 can result in forming a relatively small geometric container with respect to a detected object in motion. In the example of FIG. 3B, for a moving object having a length, width, and height of one cubic meter, an amodalization process to generate cuboid 390 can result in a cuboid having a volume less than cuboid 330 (of FIG. 3A), such as a cuboid encompassing a volume of, for example, 1.5 cubic meters, 1.3 cubic meters, 1.2 cubic meters, etc. Based on cuboid 390 encompassing a relatively small volume, vehicle computer 104 and/or off-vehicle computer 115 may consume decreased processing resources in determining the pose of a vehicle represented by sets of points 315 and 325.

In an example, velocity correction of amodalized sets of points can proceed iteratively, in which a velocity is computed based on successive scanning via lidar/radar sensor 108A. Based on a computed velocity, amodalized point sets can be modified, which can result in generating a cuboid that encompasses a set of points (e.g., 365, 375) in a smaller cuboid at a selectable and predetermined scan time of validity. Iterative adjustment of the amodalized point sets can continue in response to a generated cuboid having progressively smaller dimensions. In response to successively generated cuboids converging on particular boundaries, having straightened lines defining the boundaries of the cuboid, the iterative process can be halted.

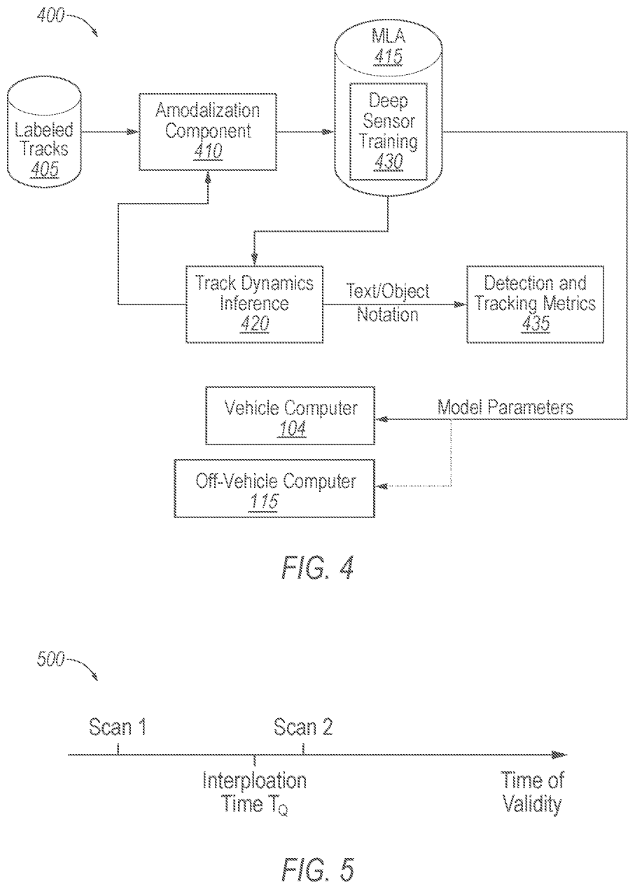

FIGS. 3A and 3B can represent a training process executed by off-line machine learning application 415 (see FIG. 4). Responsive to the iterative process of refining a cuboid to encompass detected sets of points (e.g., 365, 375) the machine learning application can adjust weights or settings utilizing characteristics of various objects in motion encountered in a traffic environment. In an example, as described further in reference to machine learning application 415, an iterative adjustment of amodalized point sets can operate to refine a cuboid to encompass detected sets of points (e.g., 365, 375). Such iterative adjustment can include processing hundreds or thousands of sets of points to obtain a set of one or more parameters, which can be uploaded into computer 104 of vehicle 100 and/or uploaded to off-vehicle computer 115. In an example, machine learning application 415 can utilize supervised learning, unsupervised learning, semi-supervised learning, reinforced learning, etc., to determine whether the machine learning application can converge on a cuboid having straightened or unbent lines defining the boundaries of the cuboid.

FIG. 4 is a schematic diagram 400 of an example training environment that generates a parameter for use in a vehicle computer 104 and/or for use by off-vehicle computer 115. In the example of FIG. 4, labeled tracks 405 can include actual (e.g., ground truth) sets of points representing objects in motion obtained utilizing output data resulting from scans performed by lidar/radar sensor 108A. In an example, labeled tracks 405 can include sets of points representing moving bicycles, moving vehicles (e.g., automobiles, sport-utility vehicles, trucks, buses, cargo vehicles, etc.), which can move in front of vehicle 100, to the sides of vehicle 100, to the rear of vehicle 100, etc. Moving objects can include objects moving laterally with respect to vehicle 100, objects moving toward vehicle 100, objects moving away from vehicle 100. In the example of FIG. 4, objects can be labeled or classified in accordance with class labels, such as “bicycle,” “compact vehicle,” “cargo vehicle,” “bus,” or utilizing another label or classification.

Amodalization component 410 represents computer executable instructions to amodalize a moving object. Accordingly, amodalization component 410 represents a process for aggregation of one or more historical sets of points of at least a portion of the object detected during one or more previous sensor scans. Historical sets of points can include points resulting from lidar or radar sensor scans of a rear portion of a moving vehicle, a side portion of the moving vehicle, a front portion of the moving vehicle, which may be aggregated via instructions executed by vehicle computer 104 and/or off-vehicle computer 115.

Point sets as well as velocities derived or inferred utilizing successive measurements from lidar/radar sensor 108A can be formatted by the input layer to include parameters, i.e., data values, such as weights or settings, and input to deep sensor training component 430 of machine learning application 415. In the example of FIG. 4, machine learning application 415 includes a neural network, such as a convolutional neural network. In this context, a convolutional neural network means a feed-forward artificial neural network with at least three layers (i.e., an input layer, an output layer, and at least one hidden layer). In an example, the input layer operates to receive a set of points, such as sets of points 365 and 375 described in relation to FIG. 3B, that represent measurement points detected by lidar/radar sensor 108A. Sets of points can be representative of relatively large objects in motion (e.g., buses, cargo vehicles, etc.) as well as relatively small objects in motion (e.g., bicycles, compact vehicles, etc.). Sets of points can additionally represent objects moving at relatively low velocities, e.g., five kilometers per hour, 10 kilometers per hour, 15 kilometers per hour, as well as objects moving at larger velocities, such as velocities of 25 kilometers per hour, 30 kilometers per hour, 40 kilometers per hour, etc., with respect to vehicle 100.

Outputs from an output layer of machine learning application 415 can be utilized to compute a loss function that represents an ability of the machine learning application to accurately predict an expected output. The loss function can be back propagated through hidden layers of machine learning application 415, incrementally altering the weights or settings stored at hidden layers of machine learning application 415, to minimize the loss function. In this context a “weight” or a “setting” means a parameter within deep sensor training component 430 that at least partly controls or governs the transformation or output of data from a machine learning application by performing an operation, e.g., addition, multiplication, convolution, or another function, to provide data, e.g., at an output layer that can be observed by a human and/or detection and tracking metrics component 435.

Responsive to the loss function being sufficiently minimized, machine learning application 415 may be considered to be trained, and the current parameters (e.g., formulated or derived from weights and/or settings within a hidden layer of machine learning application 415) can be uploaded for use by vehicle computer 104 and/or by off-vehicle computer 115.

Track dynamic inference component 420 operates to derive or infer a velocity of a set of points that represent a moving object. Thus, in an example, track dynamics inference component 420 computes an estimate of the velocity of a moving object. Thus, in an example, the velocity of an object moving laterally with respect to vehicle 100 can be estimated utilizing a first set of points detected at a time of validity T=0 and a second set of points detected at a time of validity of T=0.5 seconds. Based on the set of points being separated by 1.0 meter, the velocity of the object can be derived or inferred as traveling laterally at a velocity of 2.0 meters per second (7.2 kilometers per hour). Output signals from track dynamics inference component 420 can then be sent to amodalization component 410, which can operate to modify the amodalized set of points with the computed velocity.

As shown in FIG. 4, amodalization component 410, machine learning application 415, and track dynamics inference component 420 operate in an iterative loop. Accordingly, in an example, track dynamics inference component 420 outputs velocity corrections to amodalized sets of points computed by amodalization component 410. Velocity-corrected amodalized sets of points can then be input to machine learning application 415, which modifies parameters (e.g., weights, settings, or parameters derived from weights and/or settings) utilized by deep sensor training component 430. Machine learning application 415 can then interact with track dynamics inference component 420 to output an update to a computed or derived velocity. An updated computed or derived velocity can then be input to amodalization component 410, which utilizes the updated computed or derived velocity to output a modified amodalized set of points. The modified amodalized set of points can then be sent to machine learning application 415 for further modifications to parameters (e.g., settings or weights) of deep sensor training component 430.

In the example of FIG. 4, track dynamic inference component 420 can output a standardized text-based (e.g., JavaScript object notation) output file, which can be input to detection and tracking metrics component 435. Detection and tracking metrics component 435 can output a performance measurement of the alignment between velocity-corrected amodalized sets of points and sets of points representing output signals from a lidar sensor or from a radar sensor. In an example, detection and tracking metrics component 435 can operate to identify divergence between velocity-corrected amodalized sets of points and sets of points representing output signals from lidar/radar sensor 108A utilizing output files from track dynamics inference component 420. In another example, detection and tracking metrics component 435 can operate to identify slow convergence (i.e., hundreds of iterations, thousands of iterations, or another number of iterations without resulting in alignment between velocity-corrected amodalized sets of points and sets of points representing output signals from lidar/radar sensor 108A). In an example, divergence or slow convergence between velocity-corrected amodalized sets of points and sets of points representing output signals from lidar/radar sensor 108A can indicate that a threshold level of training of machine learning application 415 has not been performed and that additional training could be performed. In an example, amodalization component 410 can detect slow convergence between velocity-corrected amodalized sets of points and sets of points representing output signals from lidar/radar sensor 108A in response to a velocity-compensated position of sets of points and the amodalized representation of the set of points being less than a threshold value (e.g., 2%, 1%, 0.5%, etc.) in an iteration.

In response to a training process of machine learning application 415, one or more parameters can be uploaded to computer 104 of vehicle 100 and/or uploaded to off-vehicle computer 115. Such parameters can enhance the capability for vehicle computer 104 and/or off-vehicle computer 115 to align amodalized point sets that represent moving objects in a traffic environment with velocity measurements computed or derived from successive measurements from lidar/radar sensor 108A. In an example, one or more parameters uploaded from machine learning application 415 can be utilized by a pose computation component of a vehicle application that controls vehicle steering and/or propulsion, etc., responsive to detecting, classifying, and/or labeling of moving objects in the traffic environment.

FIG. 5 is an example timeline 500 showing interpolation between first and second sets of points determined via scans of a vehicle sensor, such as lidar/radar sensor 108A. In FIG. 5, the horizontal axis represents time in which a first lidar or radar scan can be modeled as occurring at a first time of validity (scan 1) and at a second time of validity (scan 2). Interpolation time T_{Q} represents a point at which an amodalized third set of points can be rendered utilizing scan 1 and scan 2. Thus, in an example, a set of points detected at the first time of validity (scan 1) can be interpolated with a set of points detected at the second time of validity (scan 2), so as to coincide with an amodalized third set of points at T_{Q}. In response to a misalignment between the interpolated set of points and the amodalized third set of points at T_{Q}, the amodalized set of points can be velocity corrected, such as described in reference to FIG. 4. In an example, further iterative adjustment of an amodalized set of points results in rendering of the amodalized third set of points at interpolation time T_{Q}. In an example, coinciding of an amodalized set of points with an interpolated set of points detected utilizing first and second times of validity (scan 1 scan 2) results in instructions executed by vehicle computer 104 and/or off-vehicle computer 115 generating a geometric container (e.g., a cuboid) having straightened, unbowed, unbent lines defining the boundaries of the generated cuboid.

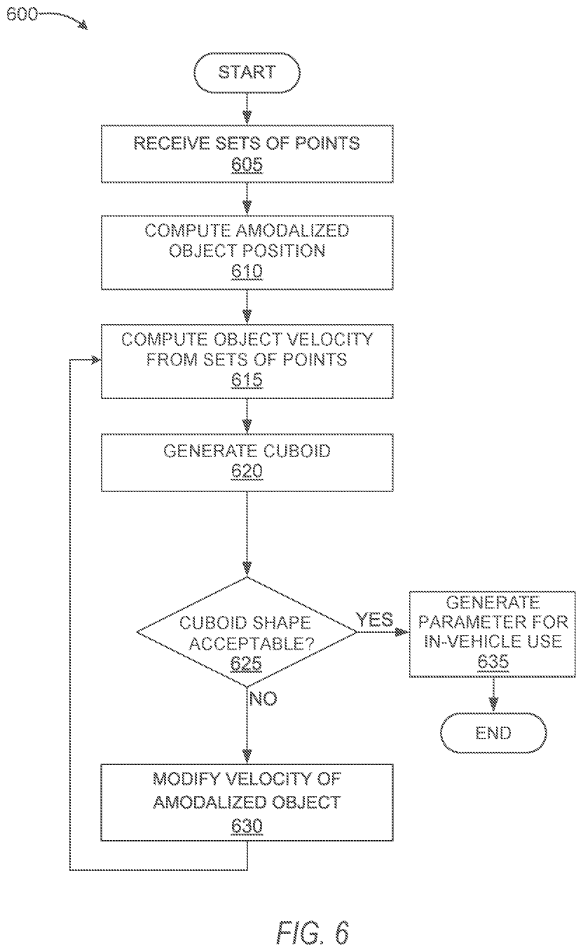

FIG. 6 is a flowchart for a process 600 of generating a velocity correction parameter in object pose determination. In an example, process 600 occurs during a training process, in which machine learning application 415 utilizes a computed velocity of a moving object, obtained via successive scans of the moving object, as an input to the amodalization process. The velocity of the moving object can be computed or derived utilizing two or more sets of points representing the moving object obtained during different or successive lidar or radar sensor scans. In an example, instructions executed by amodalization component 410, machine learning application 415, and track dynamics inference component 420 can be utilized to compute a first amodalized representation of a moving object to form a geometric container, such as a hexahedron, a cuboid, etc., which may include bent, bowed, or fattened lines defining the boundaries of the geometric container. The first amodalized representation of the moving object can represent the position of the moving object at a first selectable interpolated or third time between first and second lidar or radar sensor scans. After forming the first geometric container, the amodalization process can be executed again, utilizing the computer-derived velocity of the moving object as input signals that operate to modify the amodalized representation. A geometric container formed responsive to the second execution of the amodalization process may include a geometric container (e.g., a cuboid) having straightened, unbent, or unbowed lines defining the boundaries of the container. Based on the cuboid being less bent, less bowed, or less fattened, instructions executed by the vehicle computer can determine a second velocity of the moving object at a second selectable interpolation time, so as to align the modified amodalized representation of the object with an interpolated or third set of points derived or inferred from the scans utilizing lidar/radar sensor 108A.

Process 600 begins at block 605, which includes amodalization component 410 obtaining sets of points in response to scanning of lidar/radar sensor 108A, which may be mounted on an upper external facing portion of body 102 of vehicle 100. Sets of points may represent detected objects such as bicycles, vehicles (e.g., cars, buses, trucks recreational vehicles, etc.).

Process 600 continues at block 610, which includes amodalization component 410 computing a position of a moving object represented by sets of points. Amodalization component 410 can compute an amodalized representation of the moving object utilizing an aggregation of one or more historical sets of points of at least a portion of the detected object obtained during one or more previous sensor scans. Portions of detected objects can include side portions of moving vehicles, rear portions of moving vehicles, etc.

Process 600 continues at block 615, which includes machine learning application 415 executing instructions to compute a velocity of a moving object utilizing sets of points determined by track dynamics inference component 420 in response to successive lidar or radar scans of the moving object. In an example, a velocity of a moving object can be computed by obtaining first and second sets of points, computing displacement between the first and second sets of points and dividing by an interval between times of validity of the first and second scans.

Process 600 continues at block 620, which includes machine learning application 415 generating a cuboid, which encompasses velocity-corrected amodalized points representing the detected object. In an example, velocity correction of the amodalized set of points can include rendering the amodalized set of points at an interpolated or third time (T_{Q}) between times of validity of successive lidar or radar sensor scans, such as scan 1 and scan 2 as described in reference to FIG. 5.

Process 600 continues at block 625, at which machine learning application 415 determines whether the cuboid encompassing the velocity-corrected amodalized set of points includes fattened, bent, or bowed lines defining the boundary of the cuboid rendered at the interpolated or third time (T_{Q}). In response to the cuboid boundaries including fattened, bent, or bowed lines, process 600 continues at block 630, at which machine learning application 415 can modify the amodalized set of points representing the moving object using the derived or computed object velocity from block 615.

Process 600 returns to block 610, which includes computing a (second) amodalized object position and further refining the velocity of the moving object at block 615.

Process 600 continues at block 620, which includes generating a second cuboid to determine whether the velocity-corrected amodalized set of points includes fattened, bent, or bowed lines defining the boundary of the cuboid. Blocks 625, 630, 610, 615, and 620 may be executed iteratively until a cuboid generated at block 620 is bounded by straightened, unbent, or unbowed lines.

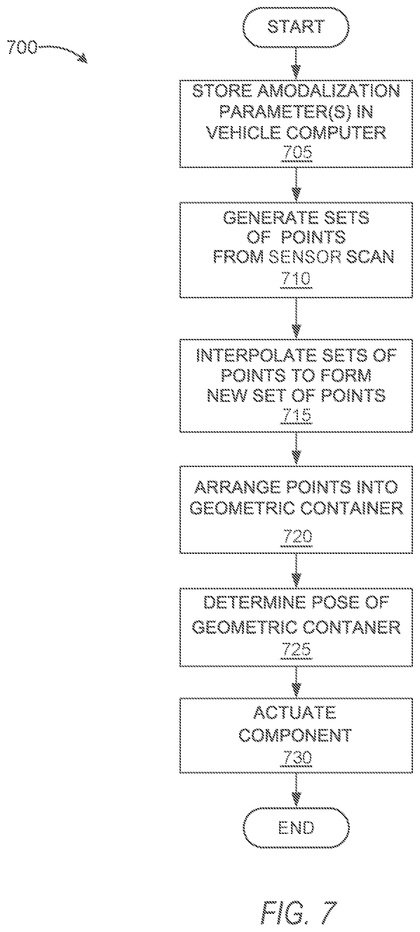

In the example of process 600, in response to machine learning application 415 determining that the cuboid encompassing the velocity-corrected amodalized set of points is acceptable, e.g., includes straightened, unbent, and/or unbowed lines defining the cuboid, block 635 can be executed. At block 635, machine learning application 415 can generate one or more parameters for in-vehicle use, such as described in reference to FIG. 7.

After executing block 635, process 600 ends.

FIG. 7 is a flowchart for a process 700 of utilizing a velocity correction parameter in a vehicle to determine the pose of an object. One or more parameters derived during the training process (blocks 605-635) can be uploaded and stored in a memory accessible to vehicle computer 104 and/or off-vehicle computer 115 to compute a velocity-corrected amodalized representation of a moving object detected in a traffic environment of vehicle 100. In an example, a process of iterating to determine a time at which amodalization, utilizing a computed or inferred velocity of a moving object, results in a geometric container (e.g., a cuboid) having substantially unbent, unbowed, lines defining the geometric container can be obtained. Via modifying an amodalized representation of a moving object to include a velocity-corrected amodalized representation of the object, vehicle computer 104 and/or off-vehicle computer 115 can compute a cuboid having straightened boundaries defining the cuboid. Hence, vehicle computer 104 and/or off-vehicle computer 115 can determine a pose of the moving object for input to a vehicle-based assisted driving application.

Process 700 begins at block 705, which includes machine learning application 415 sending one or more amodalization parameters for storage in a memory accessible to vehicle computer 104 and/or off-vehicle computer 115. Amodalization parameters can include parameters such as an interpolation or third time (T_{Q}) between validity times of lidar or radar sensor scans (e.g., scan 1 and scan 2 described in reference to FIG. 5) and/or other parameters (e.g., derived from weights or settings) of machine learning application 415 in velocity correcting an amodalized set of points.

Process 700 continues at block 710, which includes generating sets of points from lidar or radar sensor scans utilizing lidar/radar sensor 108A mounted on vehicle body 102.

Process 700 continues at block 715, which includes vehicle computer 104 and/or off-vehicle computer 115 interpolating between first and second sets of points at an interpolation or third time (T_{Q}). Block 715 can include vehicle computer 104 and/or off-vehicle computer 115 forming a third set of points from interpolated first and second sets of points.

Process 700 continues at block 720, which includes vehicle computer 104 and/or off-vehicle computer 115 arranging an interpolated or third set of points into a cuboid.

Process 700 continues at block 725, which includes determining the pose of the cuboid arranged at block 720. In an example, determining the pose of a cuboid can be utilized by an assisted driving application executing on vehicle computer 104 and/or off-vehicle computer 115.

Process 700 continues at block 730, which includes actuating a control component of vehicle 100 to control over one or more of a propulsion system, a steering system, etc., and/or HMI 112. In an example, vehicle computer 104 may control actuators 110 to execute an advanced driver assistance system (ADAS). ADAS are electronic technologies that can assist drivers in driving and parking functions. Examples of ADAS include lane-departure detection, blind-spot detection, adaptive cruise control, and lane-keeping assistance. Vehicle computer 104 may actuate a system of vehicle 100 to stop the vehicle before reaching a moving object represented by a set of points detected by lidar/radar sensor 108A, according to an algorithm that operates without human input.

After executing block 730, process 700 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above and can be accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A system, comprising:
a computer having a processor and a memory, the memory including instructions executable by the processor to:
generate first and second sets of points from first and second scans obtained from a lidar sensor or from a radar sensor;
determine a first velocity-compensated position of an object represented by a third set of points at a first validity time that is between respective times of the first and second scans;
receive a parameter from the memory of the computer, the parameter being determined from a training process to modify an amodal representation of the object, the modified amodal representation being determined from a difference between a second velocity-compensated position of the object and an unmodified amodal representation of the object; and
determine a pose of the object represented by the third set of points based on the parameter.

2. The system of claim 1, wherein the parameter is generated from an iterative adjustment of the amodal representation of the object, the iterative adjustment of the amodal representation being based on a difference between the second velocity-compensated position of the object and the modified amodal representation of the object being greater than a threshold value.

3. The system of claim 2, wherein the parameter is determined from the iterative adjustment of the amodal representation of the object terminating in response to the second velocity-compensated position of the object and the modified amodal representation of the object being less than the threshold value.

4. The system of claim 2, wherein the iterative adjustment of the amodal representation of the object occurs via supervised machine learning.

5. The system of claim 1, wherein the amodal representation of the object is determined from an aggregated history of scans of the object.

6. The system of claim 1, wherein the instructions further comprise instructions to:
generate a geometric container that includes the third set of points; and
assign a class label to the geometric container.

7. The system of claim 6, wherein the class label assigned to the geometric container is a cuboid encompassing a vehicle.

8. The system of claim 1, wherein the instructions further comprise instructions to:
actuate a vehicle component based on the determined pose of the object.

9. The system of claim 8, wherein the vehicle component is a steering component or a propulsion component.

10. The system of claim 1, wherein the parameter represents the first validity time at which the modified amodal representation of the object is computed.

11. The system of claim 10, wherein the first validity time is determined from an interpolation between the unmodified amodal representation of the object and the modified amodal representation of the object.

12. A method, comprising:
generating first and second sets of points from first and second scans obtained from a lidar sensor or from a radar sensor;
determining a first velocity-compensated position of an object represented by a third set of points at a first validity time that is between respective times of the first and second scans;
receiving a parameter from a computer memory, the parameter being determined from a training process to modify an amodal representation of the object, the modified amodal representation being determined from a difference between a second velocity-compensated position of the object and an unmodified amodal representation of the object; and
determining a pose of the object represented by the third set of points based on the parameter.

13. The method of claim 12, wherein the parameter is determined from an iterative adjustment of the amodal representation of the object, the iterative adjustment of the amodal representation being based on a difference between the second velocity-compensated position of the object and the modified amodal representation of the object being greater than a threshold value.

14. The method of claim 13, wherein the parameter is determined from the iterative adjustment of the amodal representation of the object terminating in response to the second velocity-compensated position of the object and the modified amodal representation of the object being less than the threshold value.

15. The method of claim 13, wherein the iterative adjustment of the amodal representation of the object occurs via a supervised machine learning environment.

16. The method of claim 12, wherein the amodal representation of the object is determined from an aggregated history of scans of the object.

17. The method of claim 12, further comprising:
generating a geometric container that includes the third set of points; and
assigning a class label to the geometric container.

18. The method of claim 12, further comprising:
actuating a vehicle component based on the determined pose of the object.

19. The method of claim 18, wherein the vehicle component is a steering component or a propulsion component.

20. The method of claim 12, wherein the parameter represents the first validity time at which the modified amodal representation of the object is computed.
